(19) United States
(12) Patent Application Publication
(10) Pub. No.: US 2009/0151554 A1
(43) Pub. Date: Jun. 18, 2009

(54) HYDROSTATIC DISPLACEMENT UNIT

(75) Inventors: Markus Reimer, Klein Nordende (DE); Michael Hein, Neumuenster (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 12/247,267

(22) Filed: Oct. 8, 2008

(30) Foreign Application Priority Data
Dec. 18, 2007 (DE) 20 2007 017 659.7

(51) Int. Cl. F16J 1/08; F16J 1/01; F16H 39/04

(52) U.S. Cl. 92/158; 92/172; 60/487

(57) ABSTRACT

A hydrostatic displacement unit having pistons which are composed at least partially of a high-grade aluminum material which are made of one piece or a composite to reduce wear.

### BACKGROUND OF THE INVENTION

The invention relates to a hydrostatic displacement unit as per the preamble of claim 1 and relates to displacement units which have a driveshaft and a cylinder block which has cylinder bores in which pistons are mounted in a longitudinally movable manner. The pistons are composed of a piston head, a piston shank and a piston base, the piston base being supported on a support device in such a way that, with rotation of the driveshaft, the piston head is movable in a reciprocating fashion in its cylinder. Displacement units of said type can be embodied as a pump or a hydraulic motor which can, for example, be used in traction drives as a continuously variable hydrostatic transmission.

The rotational speed limit of displacement units is limited inter alia by the wear between the piston and cylinder block. Here, a particularly critical component is the pistons whose design greatly influences the performance and service life of the displacement unit. Pistons are conventionally produced from steel. In order to keep their mass moment of inertia as low as possible and to keep the wear low, said pistons are often embodied as hollow pistons. This firstly means a considerable level of production expenditure and entails not inconsiderable costs. Secondly, pistons composed of steel therefore still have a relatively large mass moment of inertia which leads to said susceptibility to wear and to a limitation of the rotational speeds which can be obtained. The invention is based on the object of creating a hydrostatic displacement unit which is improved in this regard.

### SUMMARY OF THE INVENTION

According to the invention, the object is achieved in the displacement unit specified in the introduction by means of pistons which are composed at least partially of a high-grade aluminum material. The hydrostatic displacement unit is preferably embodied as an oblique-axle-type axial piston power unit. Alternatively, the pistons composed of high-grade aluminum produced by means of powder metallurgy are however likewise suitable for swashplate-type axial piston power units or radial piston pumps.

The pistons of the displacement unit are preferably formed in one piece. It is possible in this way to already obtain a significant reduction in the piston mass and therefore also in the instances of wear which are dependent on the piston centrifugal forces. At the same time, cost-effective production is possible from powder-metallurgical aluminum material which, as a semi-finished part or preformed, can subsequently undergo a forging, turning and/or grinding machining process.

In an alternative embodiment, the pistons are formed as composite pistons. In this way, it is possible to select the optimum material combinations for those parts of the piston which are particularly susceptible to wear, specifically the piston head and piston base in combination with the cylinder or piston base materials.

The piston is preferably formed as a hollow piston, as a result of which it is possible to obtain a further reduction in the piston mass. It is also advantageous if the piston has a longitudinal bore, in such a way that the pressure medium can pass in a metered quantity to the piston base and can serve here as lubricant in the region of the support of the piston. Here, the piston base is preferably of spherical design and is held by a corresponding ball socket of a sliding shoe or piston base or directly in the flange of the driveshaft.

It is also advantageous if the piston head is of convex or spherical design. In this way, the piston does not need to be guided linearly through a relatively long cylindrical part, but rather can perform a pivoting movement about the longitudinal axis of the cylinder within a certain angle. This is advantageous in particular in oblique-axle power units in which the pistons are supported on the drive flange of the shaft at an adjustable angle, as a result of which the piston shank travels through a certain angle range about the cylinder longitudinal axis during the reciprocating movement of the piston. The sealing of the cylinder space is provided here by one or more piston rings. Said piston rings are held by grooves which are formed in an encircling manner in the piston head.

In advantageous embodiments of the invention, in the case of a composite piston, the piston base is composed of steel and the piston shank is formed in one piece with the piston head from high-grade aluminum material, or the piston base and piston shank are formed in one piece from high-grade aluminum material, with the piston head having an insert composed of ceramic. Alternatively, the piston base can be composed of steel, the piston shank can be composed of high-grade aluminum and the piston head can be composed at least partially of steel or ceramic.

One advantage of the piston produced by means of powder metallurgy is its naturally hard and wear-resistant surface. For particular demands on the wear resistance, the surface hardness can be further improved by means of surface-finishing by means of hard anodizing. Further features and advantages of the invention can be gathered from the following description of the figures, in which:

### BRIEF DESCRIPTION OF THE FIGURES

FIG. 1: shows an oblique-axle power unit as an example of a displacement unit according to the invention;

FIG. 2: shows a solid piston;

FIG. 3: shows a hollow piston;

FIG. 4: shows a composite piston composed of steel and aluminum;

FIG. 5: shows a composite piston composed of aluminum and ceramic; and

FIG. 6: shows further examples of composite pistons.

### BRIEF DESCRIPTION OF THE PREFERRED EMBODIMENT

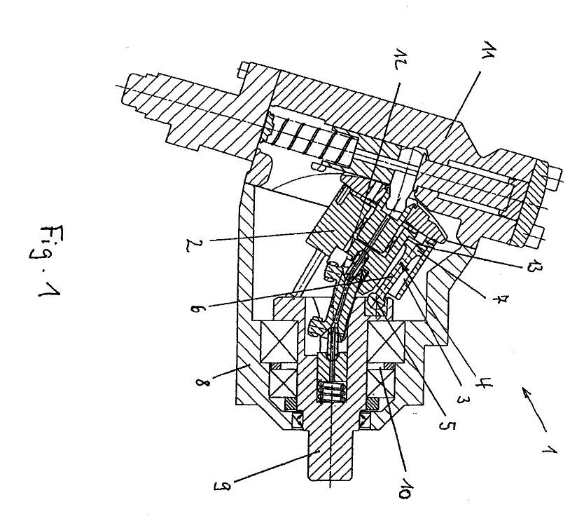

FIG. 1 shows a displacement unit 1 according to the invention as an example of a hydraulic motor embodied as an oblique-axle power unit. The unit can in principle also be operated as a pump. The displacement unit 1 has a cylinder block 2 which is mounted so as to be rotatable about its longitudinal central axis and has cylinder bores 3 distributed about its periphery, in which cylinder bores 3 pistons 4 are movable. The cylinder block 2 is mounted in the housing 8 so as to be pivotable about a pivot axis which runs transversely with respect to its rotational axis, so that the longitudinal central axis of the cylinder block 2 forms an adjustable angle with the axis of the driveshaft 9 which itself is fixedly mounted in a bearing 10 in the housing 8. Here, the pistons 4 are articulatedly supported with the piston base 5 on a support device, in this case the flange of the driveshaft 9, at the set angle. The adjustment takes place by means of an adjusting device 11, by means of which a valve segment 12 which is attached to the cylinder block 2 can be pivoted. The piston base 5 is embodied as a ball and is rotatably mounted in a ball socket of the flange of the driveshaft 9. The piston head 7 is of convex design, for example in the design of a spherical layer, and has a substantially planar end face to the side of the cylinder base 13, as is yet to be explained in detail on the basis of FIGS. 2 to 6.

The displacement unit can likewise be constructed as a swashplate power unit. Here, the pistons which are mounted in a longitudinally movable manner in the cylinder bores of the cylinder block are supported on a swashplate. Here, the piston base is held for example by a sliding shoe which rests on the contact face of the swashplate. The piston according to the invention can likewise be used in radial piston or wobble plate units as are known per se.

FIG. 2 illustrates in detail a solid piston of the displacement unit according to the invention. The single-piece piston 4 is composed of high-grade aluminum produced by means of powder metallurgy and has a spherical piston base 5, a piston shank 6 with reduced diameter and a convex piston head 7 which, in the example shown, is formed as a spherical layer and has a planar end face 15. As a result of the convex design of the piston head 7, the piston 4 can perform a pivoting movement about the longitudinal axis of the associated cylinder during its reciprocating movement in the cylinder. The piston 4 can therefore be of relatively short dimensions and need not be strictly linearly guided. In order to seal off the cylinder space, it is possible for one or more piston rings to be provided, which piston rings are held in encircling grooves 14. A piston of said type provides a considerable weight saving in relation to conventional steel pistons, which weight saving brings with it considerable advantages at the high rotational speeds which occur in practice.

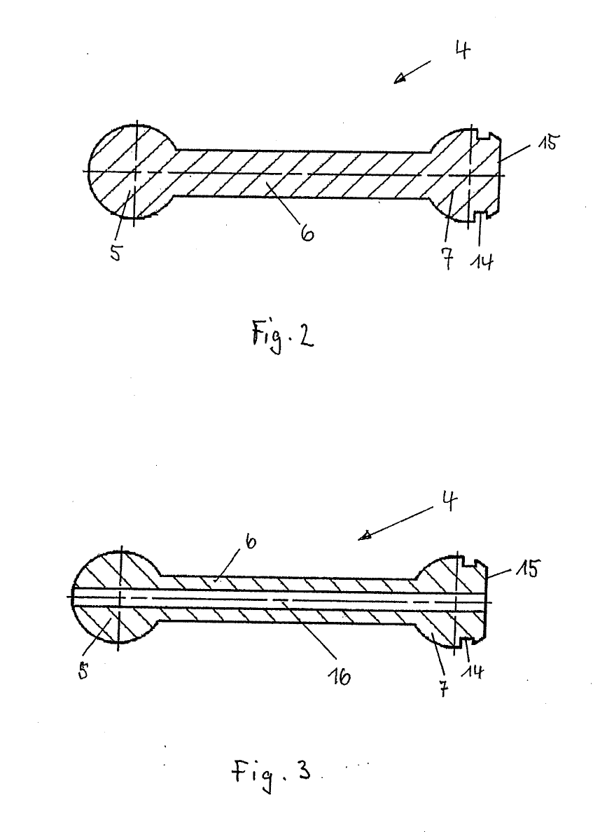

As illustrated in FIG. 3, the piston 4 can be embodied as a hollow piston. It is thereby possible to obtain a further weight saving. Here, the longitudinal bore 16 can be narrowed at its inlet and outlet points in such a way that a defined lubricant supply to the support at the piston base 5 by the pressure medium is ensured. The rest of the design corresponds to that according to FIG. 1, to the description of which reference is made in order to avoid repetition.

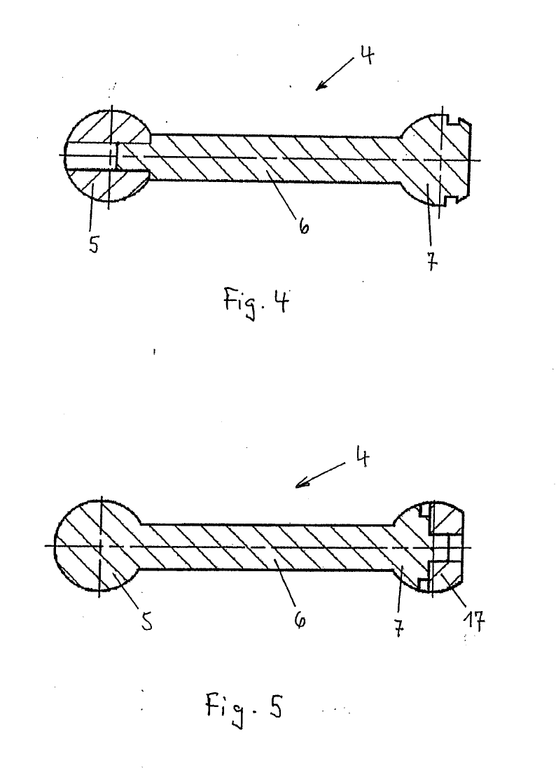

FIGS. 4 to 6 show various embodiments of pistons 4 which are embodied as composite pistons. The reference symbols for the components already described above are maintained in said figures.

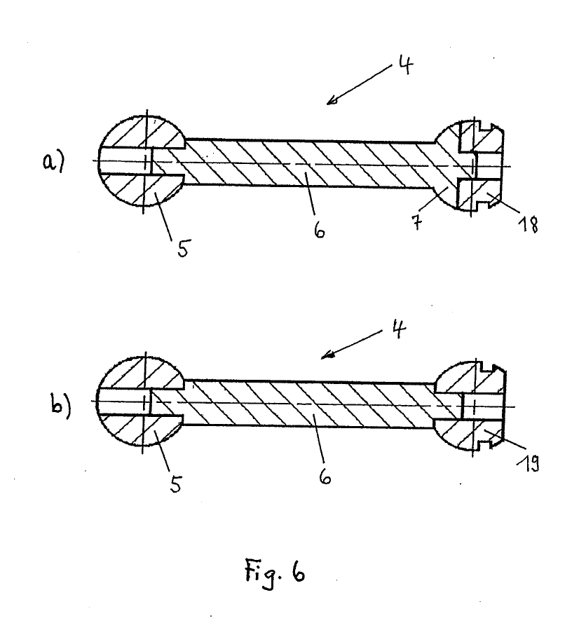

In particular cases, it has proven to be advantageous to produce the piston base 5 from steel (FIG. 4), while the piston shank 6 and the piston head 7 are, as before, produced from aluminum. In another embodiment (FIG. 5), the piston base 5 is formed together with the piston shank 6 from aluminum. The piston head 7 is provided with a ceramic insert 17 which is likewise placed in the form of a spherical layer onto the stub of the piston head 7. FIG. 6 finally shows, in embodiments a) and b), different combination possibilities which have proven to be advantageous. The piston base 5 is composed in each case of a steel ball, the piston shank 6 is composed of aluminum, while in FIG. 6a, the spherical layer of a steel insert 18 (FIG. 6a) is placed onto the stub of the piston head 7, and in FIG. 6b, the piston head as a whole is formed as a steel ball 19.

High-grade aluminum is suitable for the production of the pistons, which high-grade aluminum is produced by means of powder metallurgy and which, as a semi-finished part or after pre-forming, is forged and is mechanically finished by means of turning and grinding. The surface of the piston which is produced in this way is already naturally hard and is wear-resistant without a coating. This can be further improved by means of surface-finishing by means of hard anodizing.

By means of the invention, it is possible to obtain a mass reduction of the pistons of up to 62%. Also reduced by approximately said ratio is the piston wall force which acts as a result of the piston centrifugal force. In this way, the susceptibility to wear is reduced considerably, so that the displacement unit can also be operated at a higher rotational speed.

1. Hydrostatic displacement unit having a driveshaft (9) and having a cylinder block (2) which has cylinder bores (3) in which pistons (4) are mounted in a longitudinally movable manner, which pistons (4) have a piston head (7), a piston shank (6) and a piston base (5), with said pistons (4) being supported with the piston base (5) on a support device in such a way that, with a rotation of the driveshaft (9), the piston head (7) is movable in a reciprocating fashion in its associated cylinder bore (3), characterized in that the pistons (4) are composed at least partially of a high-grade aluminum material.

2. Hydrostatic displacement unit according to claim 1, characterized in that said hydrostatic displacement unit is embodied as an oblique-axle-type axial piston power unit.

3. Hydrostatic displacement unit according to claim 1, characterized in that said hydrostatic displacement unit is embodied as a swashplate-type axial piston power unit.

4. Hydrostatic displacement unit according to claim 1, characterized in that said hydrostatic displacement unit is embodied as a radial piston pump.

5. Hydrostatic displacement unit according to claim 1, characterized in that the piston (4) is formed in one piece.

6. Hydrostatic displacement unit according to claim 1, characterized in that the piston (4) is formed as a composite piston.

7. Hydrostatic displacement unit according to claim 1, characterized in that the piston (4) is formed as a hollow piston.

8. Hydrostatic displacement unit according to claim 1, characterized in that the piston (4) has a longitudinal bore (16) for a lubricant supply to the support of the piston base (5).

9. Hydrostatic displacement unit according to claim 1, characterized in that the piston base (5) is of spherical design.

10. Hydrostatic displacement unit according to claim 1, characterized in that the piston head (7) is of convex design and, on the side facing towards the cylinder base (13), has a substantially planar end face (15).

11. Hydrostatic displacement unit according to claim 1, characterized in that the piston head (7) has an encircling groove (14) for holding a piston ring.

12. Hydrostatic displacement unit according to claim 1, characterized in that the piston base (5) is composed of steel and the piston shank (6) and the piston head (7) are formed in one piece from high-grade aluminum material.

13. Hydrostatic displacement unit according to claim 6, characterized in that the piston base (5) and piston shank (6) are formed in one piece from high-grade aluminum and in that the piston head (7) has an insert composed of ceramic.

14. Hydrostatic displacement unit according to claim 6, characterized in that the piston base (5) is composed of steel, the piston shank (6) is composed of high-grade aluminum and the piston head (7) is composed at least partially of steel or ceramic.

15. Hydrostatic oblique-axle power unit according to claim 1, characterized in that the piston (4) is surface-finished by means of hard anodizing.
